(19) United States
(12) Patent Application Publication
(10) Pub. No.: US 2025/0262748 A1
(43) Pub. Date: Aug. 21, 2025

(54) TOOL-HOLDER PANEL, TOOL-HOLDER STRUCTURE AND KIT FOR THE ASSEMBLY OF SUCH A STRUCTURE

(71) Applicant: FAMI S.R.L., ROSA' (VICENZA) (IT)

(72) Inventor: MARCO FIETTA, TEZZE SUL BRENTA (VICENZA) (IT)

(21) Appl. No.: 19/057,313

(22) Filed: Feb. 19, 2025

(30) Foreign Application Priority Data
Feb. 20, 2024 (IT) 102024000003550

(51) Int. Cl. B25H 3/04

(52) U.S. Cl. CPC B25H 3/04

(57) ABSTRACT

A tool-holder panel that includes a main wall defining a wall unit and provided with a plurality of main holes, each configured to accommodate a hooking means for a tool or a connection means for connecting the panel to other tool-holder panels. The panel further includes a first pair of lateral walls and a second pair of lateral walls. At least one of the first and second pairs of lateral walls includes, for each lateral wall of the pair, a succession of connection holes, each configured to accommodate a connection means for connecting the panel to other tool-holder panels.

The present invention relates to a tool-holder panel which is widely used in all those places, for example workshops, garages and the like, where there is a need to hang tools and work equipment which are used with particular frequency in a such a way that they can be easily visible and accessible.

The present invention further relates to a tool-holder structure made from the aforesaid tool-holder panels and a kit for the assembly of such a structure.

To date, tool-holder panels are known, which must normally be hung on the walls of the place where the tools must be used. In such a situation, the tool-holder panel occupies a considerable portion of the wall, being particularly cumbersome and difficult to install.

In addition, since such a panel is hung on the wall, and therefore its position is fixed, if there is a need to use the tools hanging therefrom in another place, they must be removed from the panel, transported to the point of use (for example at a work counter) and subsequently returned to the panel to be placed back on it. This makes the known tool-holder panels particularly inconvenient to use.

The technical task of the present invention is thus to provide a tool-holder panel, a tool-holder structure and a kit for the assembly of such a structure which are capable of overcoming the prior-art drawbacks which have emerged.

Therefore, the object of the present invention is to provide a tool-holder panel which is practical in use.

Therefore, a further object of the present invention is to provide a tool-holder panel which can be easily coupled to other tool-holder panels if necessary. A further object of the present invention is to provide a tool-holder structure which is easy to assemble and convenient to use, in particular which allows to have at hand, at the same time, an equipped panel on which to store the tools and a workbench on which to use the tools.

The defined technical task and the specified objects are substantially achieved by a tool-holder panel, a tool-holder structure and a kit for the assembly of such a structure comprising the technical features set forth in one or more of the appended claims. The dependent claims correspond to possible embodiments of the invention.

Further features and advantages of the present invention will become more apparent from the indicative and thus non-limiting description of an embodiment of a tool-holder panel, a tool-holder structure and a kit for the assembly of such a structure.

Such a description will be set out below with reference to the accompanying drawings, which are provided solely for illustrative and therefore non-limiting purposes, in which:

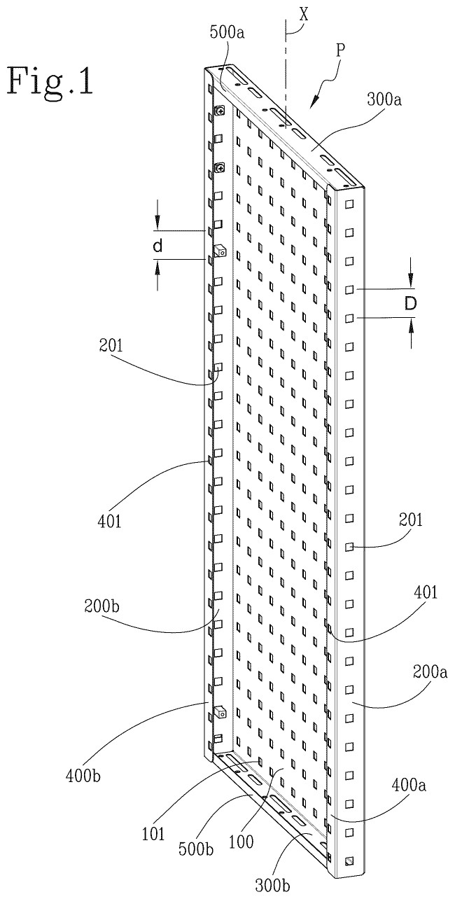

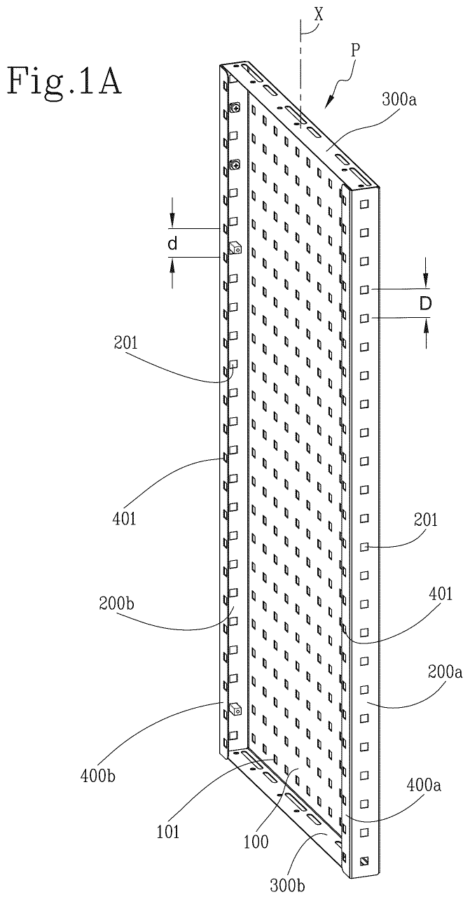

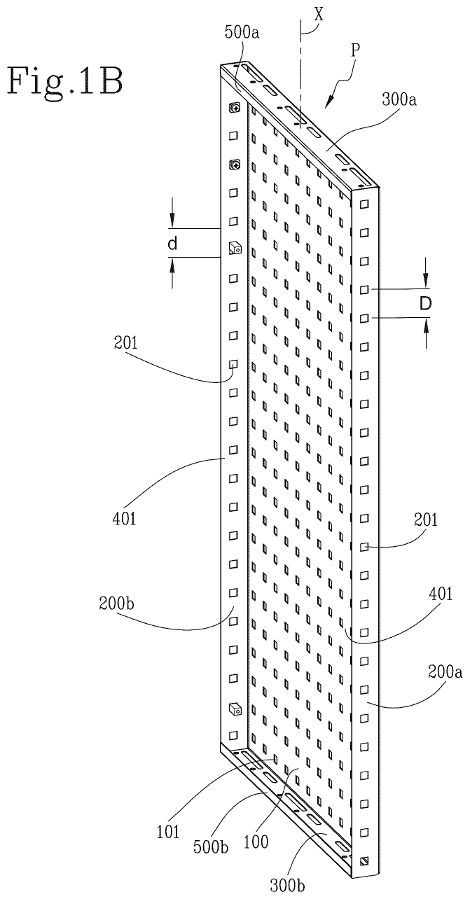

FIG. 1 shows a perspective view of a tool-holder panel which is the object of the present invention, in an embodiment;

FIG. 1A shows a perspective view of the tool-holder panel of FIG. 1, in an alternative embodiment;

FIG. 1B shows a perspective view of the tool-holder panel of FIG. 1, in a further alternative embodiment;

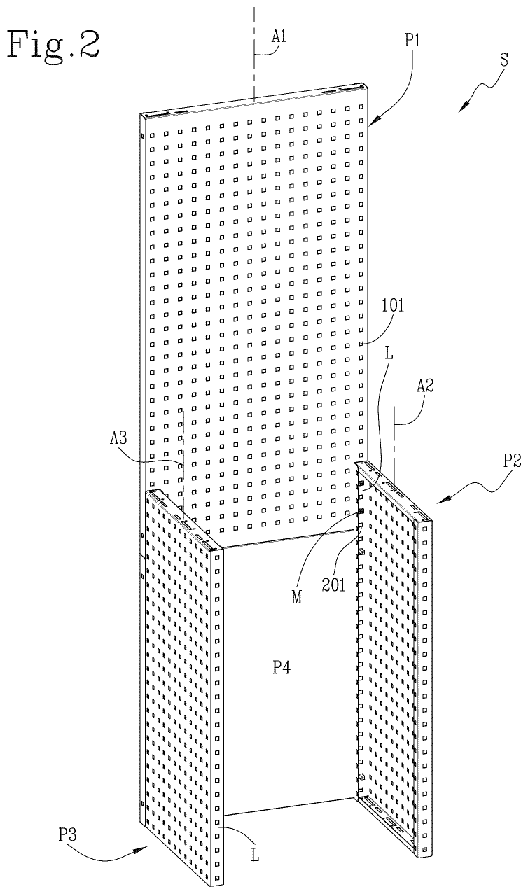

FIG. 2 shows a tool-holder structure made by combining several tool-holder panels which is the object of the present invention;

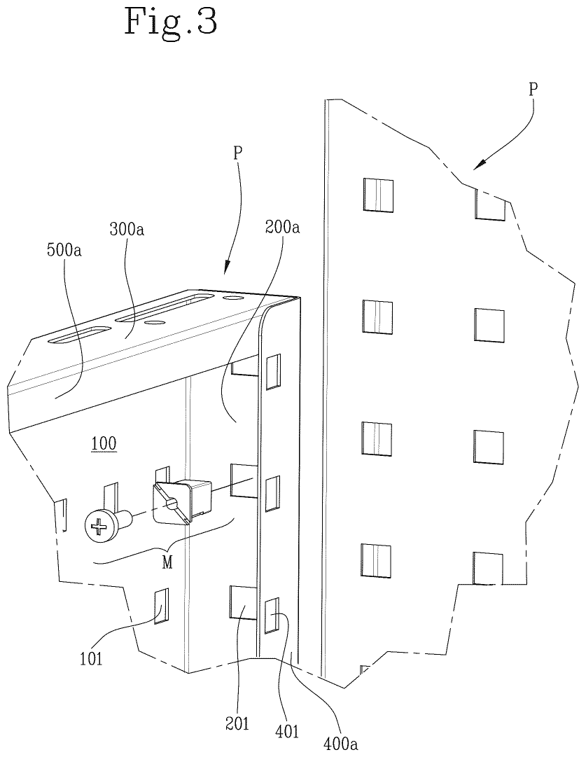

FIG. 3 shows a detail of the tool-holder panel which is the object of the present invention.

With reference to the appended figures, “P” denotes a tool-holder panel comprising a main wall 100 defining a wall unit.

The term “wall unit” means a surface to which tools or work equipment can be removably applied by hooking means.

Preferably, the panel “P” has a substantially rectangular shape.

Alternatively, the panel “P” has a substantially square shape.

The main wall 100 of the panel “P” comprises a plurality of main holes 101 each configured to accommodate a hooking means for a tool, for example a hook or a bracket, or a connection means “M”, such as a screw or a dowel or other reversible or irreversible connection means, configured to connect the panel “P” to other panels, as will be described in detail below.

With reference to the embodiment illustrated in FIG. 1, the plurality of main holes 101 is distributed on the main wall 100 in an orderly manner to define groups in which the main holes 101 of each group are aligned with each other.

That is, the plurality of main holes 101 is distributed on the main wall 100 to define a sort of matrix or grid in which the main holes 101 are aligned along rows and columns.

The panel “P” further comprises a first pair of lateral walls 200a, 200b opposite each other and extending perpendicularly to the main wall 100 starting from respective edges of the main wall 100 itself.

The panel “P” further comprises a second pair of lateral walls 300a, 300b opposite each other and extending perpendicularly to the main wall 100 starting from respective edges of the main wall 100 itself.

The first pair of lateral walls 200a, 200b cooperates with the second pair of lateral walls 300a, 300b so as to substantially define a frame for the main wall 100.

That is, the first pair of lateral walls 200a, 200b cooperates with the second pair of lateral walls 300a, 300b so as to define a sort of frame for the main wall 100.

In accordance with a possible embodiment, the panel “P” is made of metallic material. In this situation, the first and second pairs of lateral walls 200a, 200b; 300a, 300b are obtained by folding perimeter flaps of the main wall 100.

As shown in the accompanying figures, at least one of the first and second pairs of lateral walls 200a, 200b; 300a, 300b comprises, for each lateral wall 200a, 200b; 300a 300b of the pair, a succession of connection holes 201, each configured to accommodate a connection means “M” for connecting the panel “P” to other tool-holder panels.

That is, the lateral walls 200a, 200b; 300a, 300b of at least one of the first and second pairs each comprise a succession of connection holes 201 so as to be able to connect the panel “P” to other tool-holder panels.

In accordance with an aspect of the present invention, the connection holes 201 could also accommodate a hooking means to allow tools to be hooked to the lateral walls 200a, 200b; 300a, 300b.

In accordance with a possible embodiment not illustrated, the lateral walls 200a, 200b of the first pair of lateral walls 200a, 200b each comprise a respective succession of connection holes 201, just as the lateral walls 300a, 300b of the second pair of lateral walls 300a, 300b each comprise a respective succession of connection holes.

That is, both the lateral walls 200a, 200b; 300a, 300b of the first pair and those of the second pair comprise a respective succession of connection holes 201. In such a situation, the tool-holder panel “P” can be connected to other tool-holder panels (such as that described by the present invention) by means of one or more of the lateral walls 200a, 200b; 300a, 300b. In more detail, any of the lateral walls 200a, 200b; 300a, 300b of the panel “P” can be abutted to a lateral wall or a main wall of another tool-holder panel “P” so that the connection holes 201 are aligned with respective connection holes or respective main holes of the other panel “P” in order to accommodate a corresponding connection means “M”. By doing so, the panels “P” are joined and connected to each other.

In accordance with a further possible embodiment not illustrated, only the lateral walls 300a, 300b of the second pair of lateral walls 300a, 300b each comprise a respective succession of connection holes. In such an embodiment, it is possible that the lateral walls 200a, 200b of the first pair instead comprise slots to allow the panel “P” to be hung. In such a situation, the tool-holder panel “P” can be connected to other tool-holder panels (such as that described by the present invention) by means of the lateral walls of the second pair 300a, 300b. In more detail, the lateral walls 300a, 300b of the second pair can be abutted to a respective lateral wall or a respective main wall of another tool-holder panel “P” so that the connection holes of the panel “P” made on the second pair of lateral walls 300a, 300b are aligned with the connection holes or the main holes of the other panel “P” in order to accommodate a respective connection means “M”. By doing so, the panels “P” are joined and connected to each other.

In accordance with the illustrated embodiment instead, only the lateral walls 200a, 200b of the first pair of lateral walls 200a, 200b each comprise a respective succession of connection holes 201. In such a situation, it is possible that the lateral walls 300a, 300b of the second pair comprise slots to allow the panel “P” to be hung.

Preferably, each connection hole 201 is made on a respective lateral wall 200a, 200b; 300a, 300b so as to be aligned with one of the groups in which the main holes 101 of the main wall 100 are distributed.

In more detail, the distance “D” present between two successive connection holes 201 made on the same lateral wall 200a, 200b; 300a, 300b is equal to the distance present between two successive groups of main holes 101 of the main wall 100. In such a situation, each connection hole 201 is aligned with a group of main holes 101 of the main wall 100.

In the case of the illustrated embodiment, the panel “P” has a rectangular shape and therefore a main extension direction “X”. In such a situation, the first pair 200a, 200b of lateral walls is defined by the lateral walls parallel to the main extension direction “X” while the second pair of lateral walls 300a, 300b is defined by the lateral walls perpendicular to the main extension direction “X”. In such a situation, as shown in the accompanying drawings, the connection holes 201 are distributed on the respective lateral walls 200a, 200b of the first pair so as to be aligned along a direction parallel to the main extension direction “X”.

In such a situation, a connection hole 201 is spaced apart from the connection hole 201 above or below, along a direction parallel to the main extension direction “X”, by the same distance “D” at which a group of main holes 101 (i.e., a “line” of main holes 101 perpendicular to the main extension direction “X”) is spaced apart from the group below or above.

In an embodiment, illustrated in FIG. 1A, the panel “P” can comprise a first pair of auxiliary flanges 400a, 400b.

Each auxiliary flange 400a, 400b of the first pair extends perpendicularly to a respective lateral wall 200a, 200b of the first pair of lateral walls 200a, 200b starting from a free edge of such a lateral wall 200a, 200b.

The auxiliary flanges 400a, 400b of the first pair of auxiliary flanges 400a, 400b are coplanar with each other and lie on a plane parallel to the plane of the main wall 100.

In a further embodiment, illustrated in FIG. 1B, the panel “P” can comprise, as an alternative to the first pair of flanges 400a, 400b, a second pair of auxiliary flanges 500a, 500b.

Each auxiliary flange 500a, 500b of the second pair extends perpendicularly to a respective lateral wall 300a, 300b of the second pair of lateral walls 300a, 300b starting from a free edge of such a lateral wall 300a, 300b. The auxiliary flanges 500a, 500b of the second pair of auxiliary flanges 500a, 500b are coplanar with each other and lie on a plane parallel to the plane of the main wall 100.

That is, the panel “P” according to the present invention can alternatively comprise the first pair of auxiliary flanges 400a, 400b or the second pair of flanges 500a, 500b.

In a further embodiment, representing the preferred embodiment of the panel “P” according to the present invention, the panel “P” comprises the first pair of auxiliary flanges 400a, 400b and the second pair of auxiliary flanges 500a, 500b (FIG. 1).

The first and second pairs of auxiliary flanges 400a,400b,500a,500b are of the type described in the previous paragraphs.

Preferably, as shown in FIG. 1, FIG. 2, the auxiliary flanges 400a, 400b, 500a, 500b of the first and second pairs are all substantially coplanar with each other and lie on a plane parallel to the plane of the main wall 100.

The auxiliary flanges 400a, 400b; 500a, 500b of the first and second pairs face the main wall 100. In such a situation, the auxiliary flanges 400a, 400b; 500a, 500b of the first and second pairs also form a sort of frame for the main wall 100.

Preferably, each auxiliary flange 400a, 400b; 500a, 500b of at least one of the first and second pairs of auxiliary flanges 400a, 400b; 500a, 500b comprises a succession of auxiliary holes 401, each configured to accommodate a connection means “M” for connecting the panel “P” to other panels.

In detail, in the embodiment of the panel “P” having only the first pair of auxiliary flanges 400a, 400b, these can have a respective succession of auxiliary holes 401.

Alternatively, in the embodiment of the panel “P” having only the second pair of auxiliary flanges 500a, 500b, these can have the aforesaid succession of auxiliary holes 401.

In the preferred embodiment, having both the first and the second pair of auxiliary flanges 400a, 400b, 500a, 500b, the first pair of auxiliary flanges 400a, 400b and/or the second pair of auxiliary flanges 500a, 500b can have the aforesaid succession of auxiliary holes 401.

That is, in accordance with a possible embodiment not illustrated, both the first and second pairs of auxiliary flanges 400a, 400b; 500a, 500b comprise, for each flange, a respective succession of auxiliary holes 401.

In accordance with a further possible embodiment not illustrated, only the second pair of auxiliary flanges 500a, 500b comprises, for each auxiliary flange 500a, 500b of the pair, a respective succession of auxiliary holes. In such a situation, the auxiliary flanges 400a, 400b of the first pair have a continuous surface, free of holes or notches.

In accordance with the embodiment which is instead illustrated, only the first pair of auxiliary flanges 400a, 400b comprises, for each auxiliary flange 400a, 400b of the pair, a respective succession of auxiliary holes 401. In such a situation, the auxiliary flanges 500a, 500b of the second pair have a continuous surface, free of holes or notches.

As shown in FIG. 3, near the corners of the panel “P”, the auxiliary flanges 400a, 400b of the first pair of auxiliary flanges are at least partially bent over the auxiliary flanges 500a, 500b of the second pair of auxiliary flanges.

Preferably, the auxiliary holes 401 are spaced apart from each other by a distance “d” equal to the distance “D” by which the connection holes 201 are spaced apart.

With reference to the illustrated embodiments, between one auxiliary hole 401 and the next, along a direction parallel to the main extension direction “X”, there is the same distance between one connection hole 201 and the next.

In such situations, moreover, an auxiliary hole 401 is spaced apart from the auxiliary hole 401 above or below, always along a direction parallel to the main extension direction “X”, by the same distance at which a group of main holes 101 (i.e., a “line” of main holes 101 perpendicular to the main extension direction “X”) is spaced apart from the group below or above.

Preferably, the main holes 101 and the connection holes 201 have the same size and the same shape.

Even more preferably, the auxiliary holes 401 have the same shape and the same size as the main holes 101.

With reference now to FIG. 2, it shows a tool-holder structure “S” made by coupling together three tool-holder panels “P” each made in accordance with what has been described above.

In particular, the structure “S” comprises a first panel “P1” extending along a first axis of extension “A1”.

The first panel “P1” is oriented so as to have the first axis of extension “A1” perpendicular to a floor.

Preferably, the first panel “P1” has a rectangular shape.

The structure “S” further comprises a second panel “P2” extending along a second axis of extension “A2”.

Preferably, the second panel “P2” has a rectangular shape.

The structure “S” further comprises a third panel “P3” extending along a third axis of extension “A3”.

Preferably, the third panel “P3” has a rectangular shape.

Preferably, the second and third panels “P2”, “P3” have the same size while the first panel “P1” has a larger size.

In an assembly configuration (FIG. 2), the first panel “P1” is arranged so that the first axis of extension “A1” is perpendicular to the floor.

In such an assembly configuration, the second and third panels “P2”, “P3” are engaged with the first panel “P1” by means of a respective lateral wall “L” (of one of the first and second pairs of lateral walls) provided with connection holes 201 so that the second and third panels “P2”, “P3” are perpendicularly arranged with respect to the first panel “P1” and so that the second and third axis of extension “A2”, “A3” are parallel to the first axis of extension “A1”.

In such a situation, the connection holes 201 of the lateral walls “L” of the second and third panels “P2”, “P3” are aligned with the main holes 101 of the first panel “P1” and allow the insertion of a connection means “M”, such as screws.

As shown in FIG. 2, the second and third panels “P2”, “P3” are connected to the first panel “P1” so as to define respective supports for the first panel “P1” itself.

In more detail, the second and third panels “P2”, “P3” each have the lateral wall “L” provided with the connection holes 201 abutted to the first panel “P1” while they have a lateral wall of the other pair of lateral walls resting on the floor. By doing so, the first panel “P1” is supported.

As shown in FIG. 2, the second and third panels “P2”, “P3” are applied to the first panel “P1” so as to be substantially counter-facing each other.

In particular, the second and third panels “P2”, “P3” are applied to the first panel “P1” so as to be oriented on the same side with respect to the first panel “P1” itself.

In accordance with the preferred embodiment, the structure “S” further comprises a fourth panel “P4” also preferably of rectangular shape.

The fourth panel “P4” is arranged below the first panel “P1” so as to be coplanar with the first panel “P1”.

The fourth panel “P4” is also engaged with the second and third panels “P2”, “P3”. In more detail, the lateral walls “L” of the second and third panels “P2”, “P3” which are abutted to the first panel “P1” have a portion abutted to the first panel “P1” itself and a portion abutted to the fourth panel “P4”.

Therefore in use, to obtain the structure shown in FIG. 2, the first panel “P1” is arranged so as to have the first axis of extension “A1” perpendicular to the floor.

Thereafter, the fourth panel “P4” is arranged below the first panel “P1” and fixed to the lateral wall of the first panel “P1” facing the floor. In such a situation, the first panel “P1” is coplanar with the fourth panel “P4”.

Subsequently, the second and third panels “P2”, “P3” are applied to the first panel “P1”. In more detail, to perform such an application, the second panel “P2” is oriented so as to have the second axis of extension “A2” parallel to the first axis of extension “A1”. Subsequently, the second panel “P2” is approached to the first panel “P1” so that a portion of its lateral wall “L” abuts the first panel “P1” and the connection holes 201 of such a portion are aligned with respective main holes 101 of the first panel “P1”. In such a situation, the connection means “M” is inserted into the main and connection holes 101, 201 so as to fix the second panel “P2” to the first panel “P1”.

Similarly, to apply the third panel “P3”, it is oriented so as to have the third axis of extension “A3” parallel to the first axis of extension “A1”.

Subsequently, the third panel “P3” is approached to the first panel “P1” so that a portion of its lateral wall “L” abuts the first panel “P1” and the connection holes 201 of such a portion are aligned with respective main holes 101 of the first panel “P1”. In such a situation, the connection means “M” is inserted into the main and connection holes 101, 201 so as to fix the third panel “P3” to the first panel “P1”.

Preferably, the lateral walls of the first panel “P1” parallel to the first axis of extension “A1” are substantially flush with the second and third panels “P2”, “P3”.

As shown in the accompanying figures, in fact, the second and third panels “P2”, “P3” are applied to the first panel “P1” so as to be coplanar and adjacent to the lateral walls of the first panel “P1” parallel to the first axis of extension “A1”.

When assembling the second and third panels “P2”, “P3” the latter are also fixed to the fourth panel “P4”. In particular, the portions of the lateral walls “L” of the second and third panels “P2”, “P3” below the respective portions applied to the first panel “P1” are abutted to the fourth panel “P4” to be fixed thereto.

In such a situation, the second and third panels “P2”, “P3” act as supports for the first panel “P1”. In such a situation, it is possible to rest the second and third panels “P2”, “P3” on a work surface. By doing so, the second and third panels “P2”, “P3” act as supports for the work surface and for the first panel “P1” which instead acts as a real wall unit. In such a situation, an operator can grab tools hanging from the first panel “P1”, use them on the underlying work surface and subsequently place them on the first panel “P1”.

The structure “S” is therefore a structure of the stand-alone type, i.e., self-supporting. In such a situation, there is no need to hang the wall unit defined by the first panel “P1” on the wall and the structure “S” can be assembled and disassembled upon need to be easily transported.

A further object of the present invention is a kit for the assembly of a structure “S” in accordance with what has been described above.

The kit comprises a first, a second and a third panel “P1”, “P2”, “P3” each made in accordance with what has been described above.

Preferably, the first, second and third panels “P1”, “P2”, “P3” are rectangular.

Preferably, the first panel “P1” has a larger size than the second and third panels “P2”, “P3”.

Even more preferably, the second and third panels “P2”, “P3” have the same size.

Preferably, the kit further comprises a fourth panel “P4” in accordance with what has been described above.

In a possible embodiment, the fourth panel “P4” is identical to the first panel “P1”.

The kit further comprises a connection means “M” configured to reversibly connect the first, second and third panels “P1”, “P2”, “P3” to each other. The connection means “M” is inserted into the main holes 101 and/or the connection holes 201 and/or the auxiliary holes 401 of the panels “P1”, “P2”, “P3” to reversibly connect them to each other.

Preferably, the connection means “M” comprises screws.

Preferably, the connection means “M” is further configured to engage the second and third panels “P2”, “P3” to the fourth panel “P4” and to engage the fourth panel “P4” to the first panel “P1”.

According to an aspect of the present invention, the kit could further comprise a plurality of hooking means each configured to allow a hooking of a tool to the structure “S”. The hooking means is in fact configured to be inserted into the main holes 101 and/or the connection holes 201 so as to allow the tools to be hung and be clearly visible.

The kit could further comprise a movement means, for example wheels, configured to be applied, once the structure “S” is mounted, to the lateral wall of the second and third panels “P2”, “P3” facing the floor. In such a situation, the movement means allows to move the structure “S” wherever there is a need.

The present invention allows to overcome the drawbacks which have emerged in the prior art.

In particular, thanks to the presence of the connection holes 201, it is possible to easily, quickly and versatilely connect several panels “P” to each other.

For example, it is possible to connect three panels “P” together as described above, giving rise to a structure “S” of the stand-alone type which can be easily and quickly mounted wherever there is a need.

1. A tool-holder panel (P) comprising:
a main wall (100) defining a wall unit, the main wall (100) comprising a plurality of main holes (101), each configured to accommodate a hooking means for a tool or a connection means (M) for connecting said panel (P) to other tool-holder panels (P);
a first pair of lateral walls (200a, 200b) opposite each other and extending perpendicularly to said main wall (100) starting from respective edges of said main wall (100);
a second pair of lateral walls (300a, 300b) opposite each other and extending perpendicularly to said main wall (100) starting from respective edges of said main wall (100);
said first pair of lateral walls (200a, 200b) cooperating with said second pair of lateral walls (300a, 300b) so as to substantially define a frame for said main wall (100);
said panel (P) being characterised in that at least one of the first and second pairs of lateral walls (200a, 200b; 300a, 300b) comprises, for each lateral wall (200a, 200b; 300a 300b) of the pair, a succession of connection holes (201), each configured to accommodate a connection means (M) for connecting said panel (P) to other tool-holder panels (P).

2. The panel according to claim 1, comprising:
a first pair of auxiliary flanges (400a, 400b), each auxiliary flange (400a, 400b) extending perpendicularly to a respective lateral wall (200a, 200b) of the first pair of lateral walls (200a, 200b) starting from a free edge of said lateral wall (200a, 200b);
a second pair of auxiliary flanges (500a, 500b), each auxiliary flange (500a, 500b) extending perpendicularly to a respective lateral wall (300a, 300b) of the second pair of lateral walls (300a, 300b) starting from a free edge of said lateral wall (300a, 300b);
the auxiliary flanges (400a, 400b; 500a, 500b) of the first and second pairs facing said main wall (100).

3. The panel according to claim 1, wherein only the lateral walls (200a, 200b) of the first pair of lateral walls (200a, 200b) each comprise a respective succession of connection holes (201).

4. The panel according to claim 1, wherein only the lateral walls (300a, 300b) of the second pair of lateral walls (300a, 300b) each comprise a respective succession of connection holes.

5. The panel according to claim 1, wherein the lateral walls (200a, 200b) of the first pair of lateral walls (200a, 200b) each comprise a respective succession of connection holes (201) and the lateral walls (300a, 300b) of the second pair of lateral walls (300a, 300b) each comprise a respective succession of connection holes.

6. The panel according to claim 1, wherein said plurality of main holes (101) are distributed over the main wall (100) in an orderly manner in order to define groups in which the main holes (101) of each group are aligned with each other, and wherein each connection hole (201) is made on a respective lateral wall (200a, 200b; 300a, 300b) so as to be aligned with one of said groups.

7. The panel according to claim 2, wherein each auxiliary flange (400a, 400b; 500a, 500b) of at least one of the first and second pairs of auxiliary flanges (400a, 400b; 500a, 500b) comprises a succession of auxiliary holes (401), each configured to accommodate a connection means (M) for connecting said panel (P) to other panels (P).

8. The panel according to claim 7, wherein the auxiliary holes (401) are spaced apart from each other by a distance (d) equal to the distance (D) by which the connection holes (201) are spaced apart from each other.

9. The panel according to claim 1, wherein the main holes (101) and the connection holes (201) have the same size and same shape.

10. The panel according to claim 7, wherein the auxiliary holes (401) have the same shape and the same size as the main holes (101).

11. A tool-holder structure(S), comprising:
a first panel (P1) constructed in accordance with claim 1, said first panel (P1) extending along a first axis of extension (A1);
a second panel (P2) constructed in accordance with claim 1, said second panel (P2) extending along a second axis of extension (A2);
a third panel (P3) constructed in accordance with claim 1, said third panel (P3) extending along a third axis of extension (A3);
connection means (M) configured to reversibly connect the second and third panels (P2, P3) to said first panel (P1);
said first panel (P1) being arranged, in an assembly configuration, in such a way that said first axis of extension (A1) is perpendicular to the floor; said second and third panels (P2, P3) being, in said assembly configuration, engaged to said first panel (P1) by means of a respective lateral wall (L) provided with connection holes (201) so that said second and third panels (P2, P3) are arranged perpendicularly to said first panel (P1) and said second and third axes of extension (A2, A3) are parallel to the first axis of extension (A1).

12. A kit for the assembly of a structure(S) according to claim 11, comprising:
a first, a second and a third panel (P1, P2, P3), each constructed in accordance with claim 1;
connection means (M) configured to reversibly connect the first, second and third panels (P1, P2, P3) to each other.
